(19) United States
(12) Patent Application Publication
(10) Pub. No.: US 2002/0124415 A1
(43) Pub. Date: Sep. 12, 2002

(54) Scissors type cutting tool

(75) Inventors: Hirokazu Mizutani, Kamagaya-shi (JP); Yuichi Sakai, Sanjo-shi (JP)

Correspondence Address: KODA & ANDROLIA, Suite 3850, 2029 Century Park East, Los Angeles, CA, 90067-3024, US

(73) Assignee: MIZUTANI SCISSORS MFG CO., LTD.

(21) Appl. No.: 10/092,412

(22) Filed: Mar. 5, 2002

(30) Foreign Application Priority Data
Mar. 6, 2001 (JP) 2001-061224

(51) Int. Cl. B26B 13/28

(52) U.S. Cl. 30/261; 30/266

(57) ABSTRACT

A cutting tool such as a pair of scissors including two main cutting bodies that have blade portions and connected so as to pivot relative to each other about a pivot shaft. A spring is disposed in a space formed by the recessed portions formed in inside surfaces of the main cutting bodies so as to surround shaft holes of the main cutting bodies. The spring has two operating ends each acting on some point inside the separate recessed portion of each one of the main cutting bodies so as to apply a driving force that opens the blade portions.

### BACKGROUND OF THE INVENTION

1. Field of the Invention

The present invention relates to a cutting tool such as haircutting scissors, a cuticle cutter, a nail cutter, etc., which exerts a cutting action by causing a pair of main cutting bodies to pivot about a pivot shaft.

2. Prior Art

In conventional scissors type cutting tools, a plate-form spring, a coil spring, etc. is interposed between handles in order to drive the blades in the direction that opens the blades.

In such conventional cutting tools, the plate-form spring or coil the spring is exposed, and as a result, the appearance of the cutting tool tends to be poor. Especially for cosmetic tools such as haircutting scissors, cuticle cutters, nail cutters, etc., such exposed components deteriorates the appearance the cutting tools.

### SUMMARY OF THE INVENTION

Accordingly, it is an object of the present invention to provide a cutting tool in which the spring that is employed for driving the blades of the cutting tools in directions that opens the blades is installed so as not be seen from outside.

The above object is accomplished by a unique structure of the present invention for a cutting tool such as a pair of scissors in which two main cutting bodies each comprising a blade portion and a handle section are connected by a pivot shaft so as to pivot relative to each other about the pivot shaft provided between the blade portion and the handle section, and the blade portions are driven in an opening direction by a spring; and in the present invention,

each one of the main cutting bodies is formed with a recessed portion in inside surface thereof so as to surround a shaft hole opened in each one of the main cutting bodies;

a spring is installed in a space that is formed by the recessed portions that are disposed to face each other;

the spring has two operating ends for applying a driving force that urges the blade portions in the opening direction, and

one of the two operating ends of the spring acts on a point in the recessed portion of one of the main cutting bodies and another one of the two operating ends of the spring acts on a point in the recessed portion of another one of the main cutting bodies.

In the above structure, the point where the two operating ends of the spring act in order to apply a driving force that opens the blade portions are located further toward the handle section with respect to an imaginary line that passes through a center of the shaft hole and is perpendicular to a direction of length of the blade portion.

Furthermore, in the above structure, the spring is a coil spring, the pivot shaft is passed through an interior of a cylindrical coil section of the spring, both end portions of a spring wire that forms the cylindrical coil section are bent substantially in opposite directions from each other so as to form the operating ends, and one of the operating ends is engaged with an anchoring hole formed in a bottom of the recessed portion of one of the main cutting bodies and another one of the operating ends is engaged with an anchoring hole formed in a bottom of the recessed portion of another one of the main cutting bodies.

In addition, in the present invention, it is possible to structure so that the spring is a coil spring, the pivot shaft is passed through an interior of a cylindrical coil section of the spring, two arm portions protrude in a fan shape from the cylindrical coil section of the spring so that each end of the arm portions are bent substantially in opposite directions from each other so as to form the operating ends, and one of the operating ends is engaged with an anchoring hole formed in a bottom of the recessed portion of one of the main cutting bodies and another one of the operating ends is engaged with an anchoring hole formed in a bottom of the recessed portion of another one of the main cutting bodies.

It is also possible to use a coil spring is used as the spring, the pivot shaft is passed through an interior of a cylindrical coil section of the spring, two arm portions protrude in a fan shape from the cylindrical coil section of the spring, and one of the two arms is engaged with an inner surface of the recessed portion of one of the main cutting bodies and another one of the operating ends is engaged with an inner surface of the recessed portion of another one of the main cutting bodies.

In the present invention, the spring that drives the blade portions in the opening direction is disposed inside the space that is obtained by the recessed portions that are formed around the shaft holes of the main cutting bodies and set so as to face each other. Accordingly, the recessed portion of one cutting body is covered by another cutting body, and thus the spring installed in a space formed by such recessed portions is not exposed. As a result, the cutting tool can have a good external appearance.

In common scissors, the inside surfaces of the blade portions are ground from the tip ends to points located slightly further toward the handle sections than the shaft holes (this is called back grinding), so that the height of the inside surfaces is lowered. The inside surfaces located further toward the handle sections than these points are not ground, so that the height is left “as is,” thus forming contact points, and the pair of blade portions are driven so that these blade portions are pressed together by the mutual pressing contact of the contact points.

In the present invention, when the two operating ends of the spring apply a driving force that opens the blade portions, there may be cases in which not all of the elastic force of the spring acts as this driving force, with a portion of the elastic force acting in the direction that causes the connected pair of main cutting bodies to separate. Accordingly, in cases where the operating positions of the spring inside the recessed portions are located further toward the blade portions than a line that passes through the centers of the shaft holes and is perpendicular to the direction of length of the blade portions, there is a danger that might act so that the connected blade portions are separated, thus making it impossible to cut hair, etc.

In the present invention, as described above, the point where the two operating ends of the spring act in order to apply a driving force that opens the blade portions are located further toward the handle section with respect to an imaginary line that passes through a center of the shaft hole and is perpendicular to a direction of length of the blade portion.

Accordingly, in cases where a portion of the elastic force of the spring acts in the direction that causes the connected pair of main cutting bodies to separate, the blade portions are driven so that the blade portions are pressed together as in the case of the contact point; therefore, the blade portions are not separated from each other. Furthermore, if the blade portions are driven by the spring so that the blade portions are pressed together, then scissors that are sufficiently usable can be provided even if contact points are not formed by back grinding. Since the back grinding of scissors requires a high degree of skill, the cost can be reduced since no back grinding is required in the present invention.

Furthermore, in the present invention, the spring is a coil spring, the pivot shaft is passed through an interior of a cylindrical coil section of the spring, both end portions of a spring wire that forms the cylindrical coil section are bent in opposite directions from each other so as to form the operating ends, and the operating ends are engaged with anchoring holes formed in the bottom of the recessed portions, so that the spring provides a driving force to open the blade portions.

In this structure, since the spring is literally a circular coil, the spring is provided along the circumference of the pivot shaft. Accordingly, even if the blade portions are widely opened, there is no exposure of the spring, so that the appearance is greatly improved.

Furthermore, it is possible in the present invention to design so that the tip ends of the anchoring projections press against the anchoring holes in the recessed portions. In this structure, by way of providing the anchoring holes so as to be located further toward the handle sections than a line that passes through the centers of the shaft holes and is perpendicular to the direction of length of the blade portions, the driving force can be applied so that the blade portions are pressed together,

Furthermore, in the present invention, two arm portions that protrude in a fan shape from the cylindrical coil section are formed on both end portions of the spring wire, the portions of both arm portions that are located in the vicinity of the tip ends of the arm portions are bent more or less in opposite directions so as to form the anchoring projections, and the anchoring projections are anchored in anchoring holes formed in the bottoms of the recessed portions formed in the inside surfaces of the main cutting bodies, so that a driving force that opens the blade portions is applied.

As seen from the above, the spring consists of a circular cylindrical coil section and fan-shaped arm portions that protrude from this cylindrical coil section as integral parts. Accordingly, by way of providing the anchoring holes further toward the handle sections than a line that passes through the centers of the shaft holes and is perpendicular to the direction of length of the blade portions, then the driving force is applied so that the blade portions are pressed together. Furthermore, since the driving force that presses the blade portions together can be applied also by the arm portions, the driving force can be increased.

In addition, in the present invention, two arm portions that protrude in a fan shape from the cylindrical coil section are formed on both end portions of the spring wire, and the driving force that opens the blade portions is applied as a result of these arm portions pressing against the inside circumferential surfaces of the recessed portions formed in the inside surfaces of the main cutting bodies. Accordingly, there is no need to bend the end portions of the arm portions, and there is no need to form anchoring holes inside the recessed portions. Consequently, the manufacture and assembly of the cutting tool can be simplified.

### BRIEF DESCRIPTION OF THE DRAWINGS

FIG. 1 is a front view of the scissors according to the present invention;

FIG. 2 is a partial view of the area near the pivot shaft of one of the main cutting bodies of the scissors according to the first embodiment of the present invention;

FIG. 3 is a partial view of the area near the pivot shaft of another of the main cutting bodies thereof;

FIG. 4 is a partial view of one of the main cutting bodies shown in cross-section;

FIG. 5A is a perspective view of the coil spring, 5B is a top view thereof, and 5C is a side view thereof;

FIG. 6 shows a part of the main cutting bodies connected by the pivot shaft;

FIG. 7 is a partial view of the area near the pivot shaft of one of the main cutting bodies of the scissors according to the second embodiment of the present invention;

FIG. 8A is a perspective view of the coil spring used in the embodiment of FIG. 7, and 8B is a top view thereof;

FIG. 9 shows a part of the main cutting bodies connected by the pivot shaft according to the second embodiment of the present invention;

FIG. 10 is a front view of still another embodiment of the present invention applied to a cuticle cutter; and

FIG. 11 is a sectional view of the area near the pivot shaft of the cuticle cutter of FIG. 10.

### DETAILED DESCRIPTION OF THE INVENTION

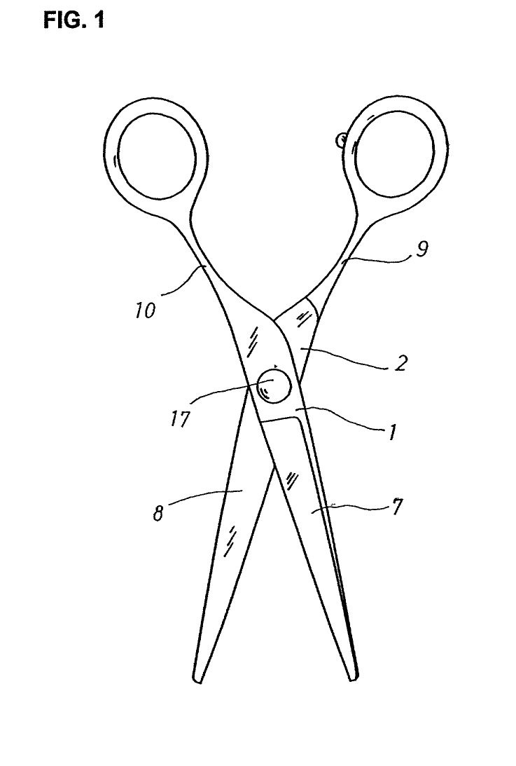

Embodiments of the present invention will be described with reference to the accompanying drawings. FIGS. 1 through 9 illustrate the present invention applied to haircutting scissors.

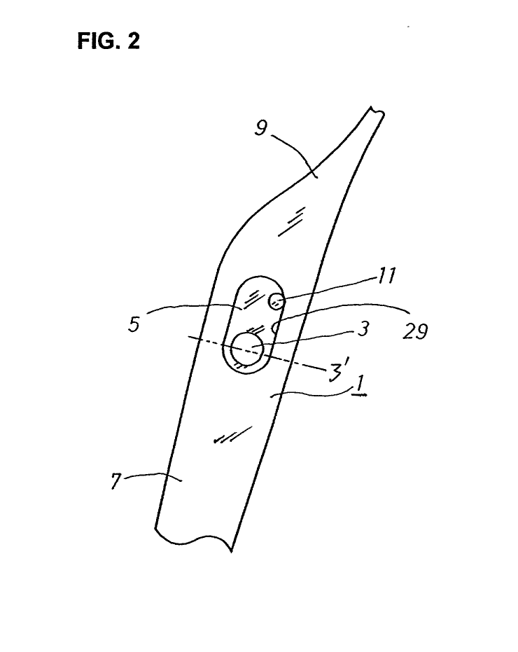

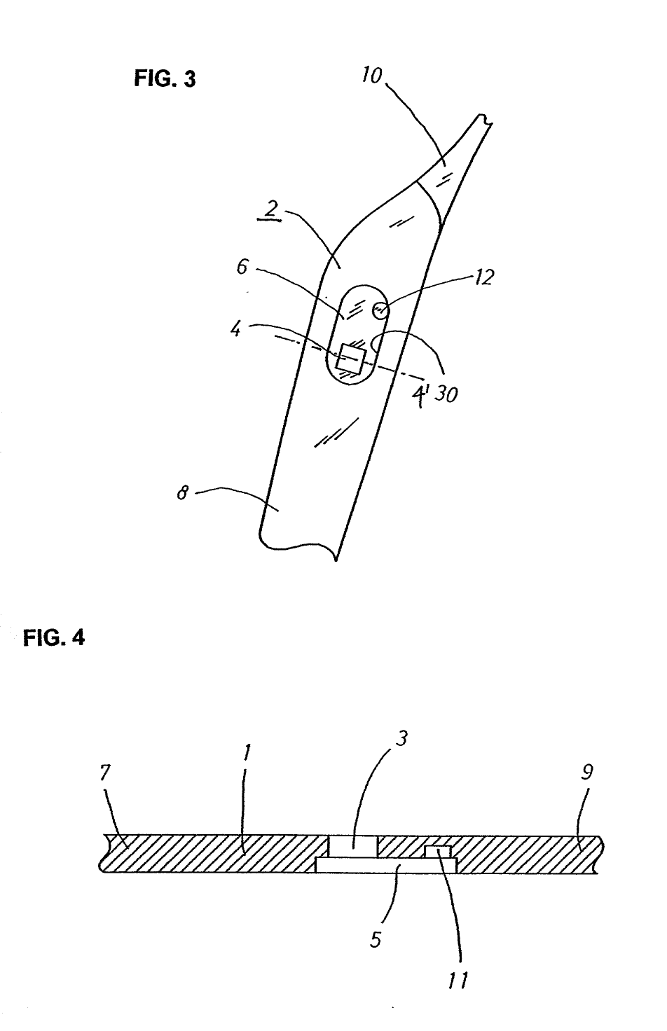

The scissors, as seen from FIG. 1, comprises a pair of main cutting bodies 1 and 2. The main cutting body 1 includes a blade portion 7 and a handle section 10. The other main cutting body 2 includes a blade portion 8 and a handle section 9. The main cutting body 1 is provided with a shaft hole 5, as shown in FIG. 2, between the blade portion 7 and the handle section 10. The main cutting body 2 is, as seen from FIG. 3, provided with a shaft hole 6 between the blade portion 8 and the handle section 10.

Oval-shaped recessed portions 5 and 6 are formed in the inside surfaces of the main cutting bodies 1 and 2 so as to be around shaft holes 3 and 4. The recessed portions 5 and 6 are long in the direction of length of the main cutting bodies 1 and 2. The recessed portion 5 is provided in the main cutting body 1, and the recessed portion 6 is provided in the main cutting body 2.

The shaft holes 3 and 4 are respectively located in the recessed portions 5 and 6 so that the shaft holes 3 and 4 are offset toward the blade portions 7 and 8. In other words, as seen from FIG. 2, the shaft hole 3 of the main cutting body 1 is on the blade portion 7 side in the recessed portion 5; and as seen from FIG. 3, the shaft hole 4 of the main cutting body 2 is on the blade portion 8 side in the recessed portion 6.

Furthermore, anchoring holes 11 and 12 are formed in the bottoms of the recessed portions 5 and 6, so that the anchoring holes 11 and 12 are offset toward the handle sections 9 and 10. In other words, as seen from FIG. 2, anchoring hole 11 of the main cutting body 1 is on the handle section 9 side in the recessed portion 5; and as seen from FIG. 3, the anchoring hole 12 of the main cutting body 2 is on the handle section 10 side in the recessed portion 6.

As is clear particularly from FIGS. 2 and 3, these anchoring holes 11 and 12 are respectively provided further toward the handle sections 9 and 10 than imaginary lines 3′ and 4′ that passes through the centers of the shaft holes 3 and 4 and is perpendicular to the direction of length of the blade portions.

FIG. 4 shows, in cross section, the area near the shaft hole 3 of one of the main cutting bodies 1. The shaft hole 3 is a through hole, and the anchoring hole 11 is formed further deep in the bottom of the recessed portion 5. Though not shown, the other main cutting body 2 has substantially the same structure as that shown in FIG. 4.

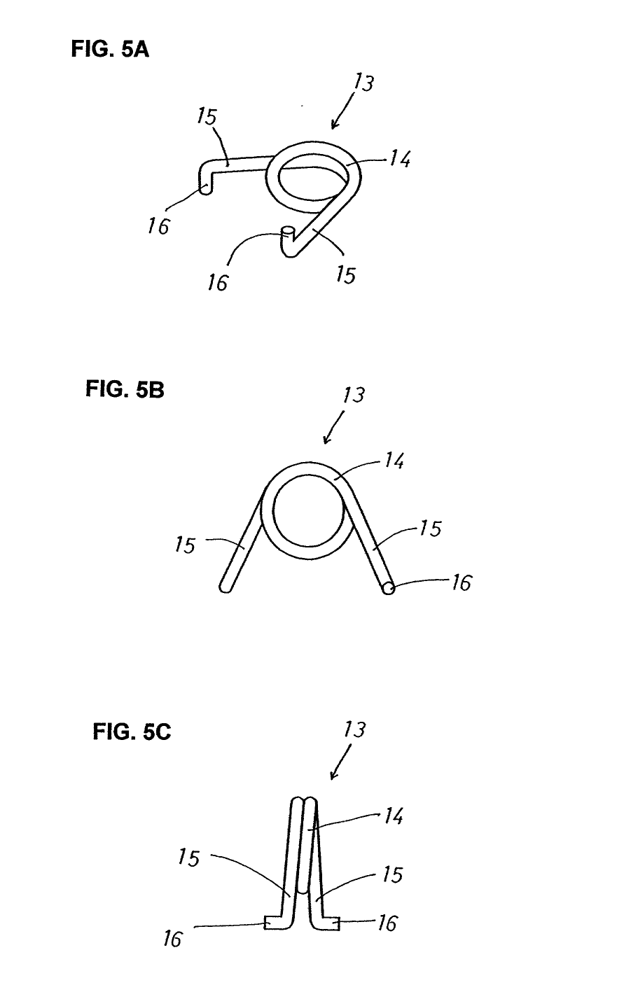

FIGS. 5A, 5B and 5C show a coil spring 13 that is used in the scissors of the present invention. In this coil spring 13, the cylindrical coil section 14 is obtained by coiling a wire one and a half turns with arm portions 15 protruding in a fan shape from both ends of the cylindrical coil section 14. Tip ends of the arm portions 15 are bent perpendicularly in opposite directions with respect to the axis of the coil spring 13, thus forming anchoring projections 16.

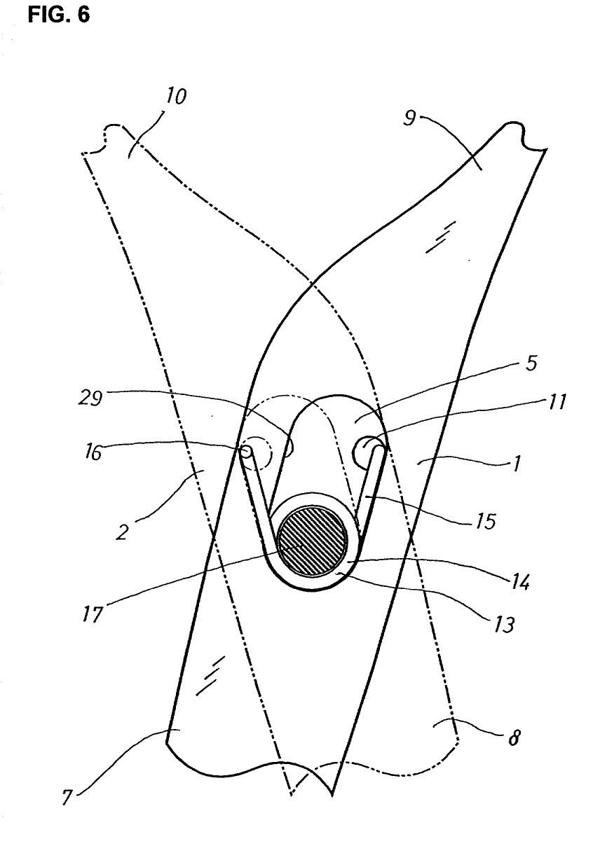

In assembling, a pivot shaft 17 is inserted into the shaft hole 3 of the main cutting body 1, and the coil spring 13 is mounted on the pivot shaft 17 so that the cylindrical coil section 14 of the coil spring 13 surrounds the pivot shaft 17 (or passing the pivot shaft 17 through the cylindrical coil section 14 of the coil spring 13) as seen from FIG. 6. Then, one of the anchoring projections 16 is inserted into the anchoring hole 11. Next, the main cutting body 2 is connected to the pivot shaft 17 by way of inserting the shaft hole 4 thereon into the pivot shaft 17. The other anchoring projection 16 of the coil spring 13 is inserted into the anchoring hole 12 of the main cutting body 2. Finally, the pivot shaft 17 is fastened in place by means of a nut (not shown).

As a result, the pair of main cutting bodies 1 and 2 are urged by the coil spring 13 so that the blade portions 7 and 8 are driven by the coil spring 13 in the direction (“opening direction”) that opens the blade portions 7 and 8 as shown in FIG. 1. As a result, under ordinary conditions, the blade portions 7 and 8 are kept opened. It is thus preferable to use a means that keeps the blade portions 7 and 8 closed when the scissors are not in use.

In the above coil spring 13, the anchoring projections 16 can be omitted at the tip ends of the arm portions 15. In such a case, the anchoring holes 11 and 12 can be also omitted. When such a coil spring with no anchoring projections formed is used, the coil spring is set so that the arm portions 15 press against the inside circumferential surfaces 29 and 30 of the recessed portions 5 and 6 of the main cutting bodies 1 and 2. As a result, the blade portions 7 and 8 are driven in the opening direction by the coil spring that has no anchoring projections at the ends of the arm portions.

It is indeed not necessary that the spring be a coil spring. For instance, a spring in which the spring wire is bent into a U shape with both ends spread in opposite directions can be employed. When such a U shape spring is used, it is necessary to twist the bent portion of the spring so that both straight portions of the spring are inserted respectively in different recessed portions 5 and 6.

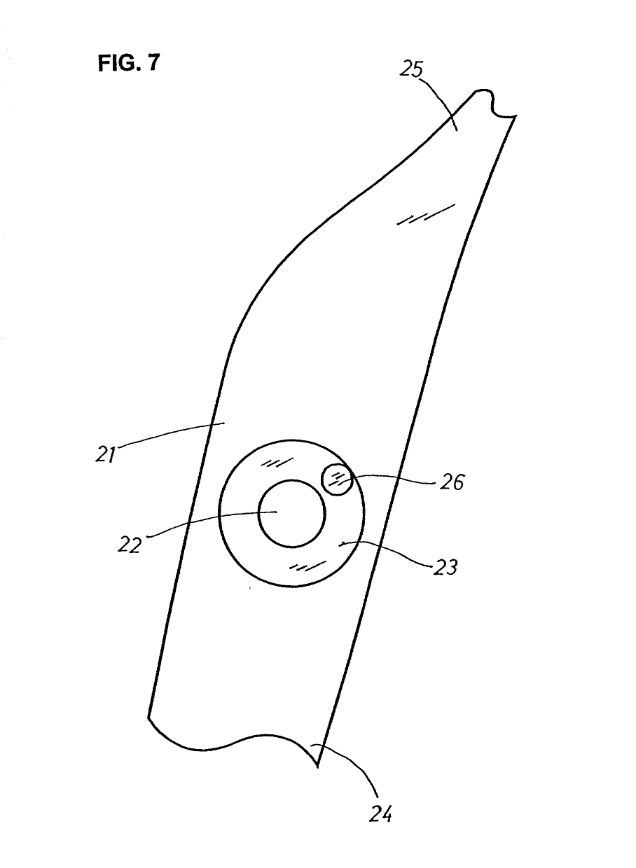

FIG. 7 shows the second embodiment of the present invention.

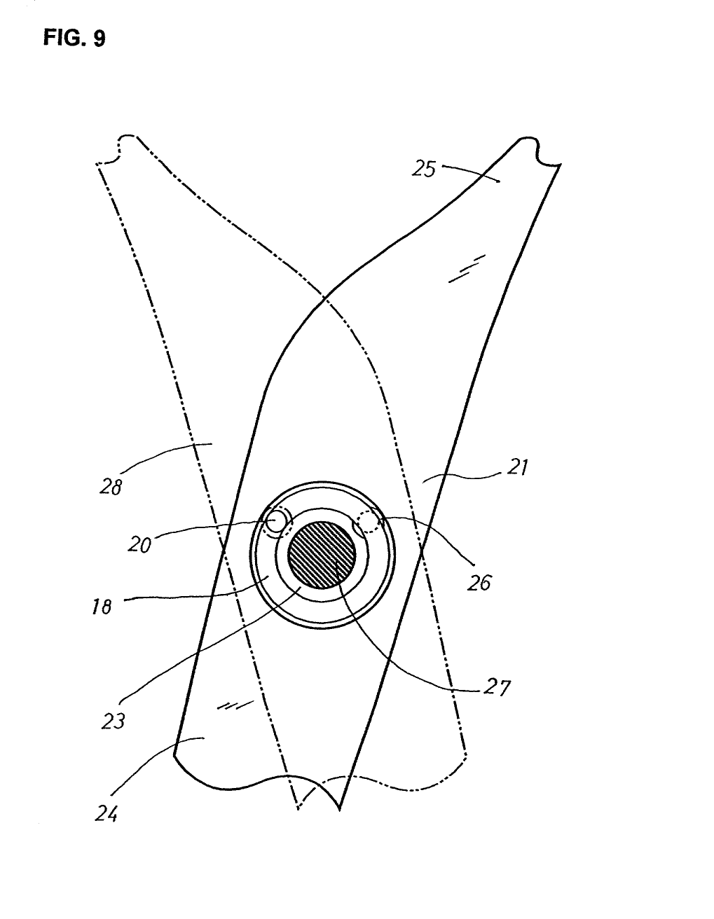

In this second embodiment, a recessed portion 23 is circular in shape and is formed so as to surround the shaft hole 22 of the main cutting body 21, and an anchoring hole 26 is formed further toward the handle section 25 of the cutting body 21 than a line that passes through the center of the shaft hole 22 and is perpendicular to the direction of length of the blade portion 24. For the other main cutting body 28 (see FIG. 9), a recessed portion, a shaft hole and an anchoring hole are formed in substantially the same manner as each one of those elements of the main cutting body 21 shown in FIG. 7.

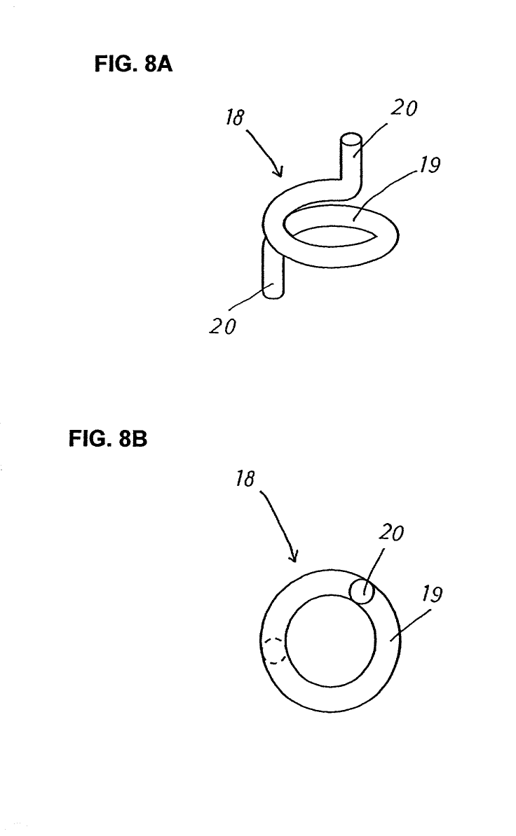

FIG. 8 shows the coil spring used in the second embodiment.

In this coil spring 18, the cylindrical coil section 19 is bent at both ends so as to form anchoring projections 20 that extend in opposite directions from each other.

When this coil spring 18 is used, as seen from FIG. 9, the pivot shaft 27 is inserted in the shaft holes of the main cutting bodies 25 and 28, the coil spring 18 sandwiched by the main cutting bodies 25 and 28 is mounted on the pivot shaft 27 with the cylindrical coil section 19 surrounding the pivot shaft 27, and the anchoring projections 20 of the coil spring 18 are engaged with the anchoring holes 26 of the main cutting bodies 25 and 28.

In this embodiment, as is clear from FIG. 8, the coil spring 18 has no such arms 15 of the coil spring 13 as shown in FIGS. 5A through SC. Also, the recessed portions 23 are circular and surround the shaft holes of the main cutting bodies and snugly accommodate the coil spring 18 therein. Accordingly, the recessed portions 23 are completely covered by the main cutting bodies 21 and 28; and even when the blade portions of the main cutting bodies are completely opened, there is absolutely no exposure of the recessed portions 23 or the coil spring 18.

When the coil spring 18 is of a shallow type and has the same height in its axial direction as the thickness of either one of the main cutting bodies 25 and 28, then the recessed portion 23 (and the anchoring hole 26) is formed in either one of the main cutting bodies 25 and 28.

Haircutting scissors having respectively different shape coil springs are described above; and the shown haircutting scissors have handle sections. However, the present invention is indeed applicable to scissors with no handle sections. Thus, such a structure in which the main cutting bodies are cut off at positions slightly to the rear side of the shaft holes is also possible. In such a case, the scissors have a shape of the type used in gardening shears, and compact scissors are obtained.

Furthermore, since the cylindrical coil section of the coil spring used in the present invention is wound, one anchoring projection naturally enters one of the recessed portions, while the other anchoring projection naturally enters the other recessed portion. In addition, even without forcibly opening the overlapping cylindrical coil sections of the coil spring so as to be separated, the arm portions 15 and anchoring projections 16 of the coil spring often act to separate the pair of main cutting bodies during use, and the pair of blade portions are driven by this action so that the blade portions are pressed together. Consequently, the coil spring also has the action of contact points.

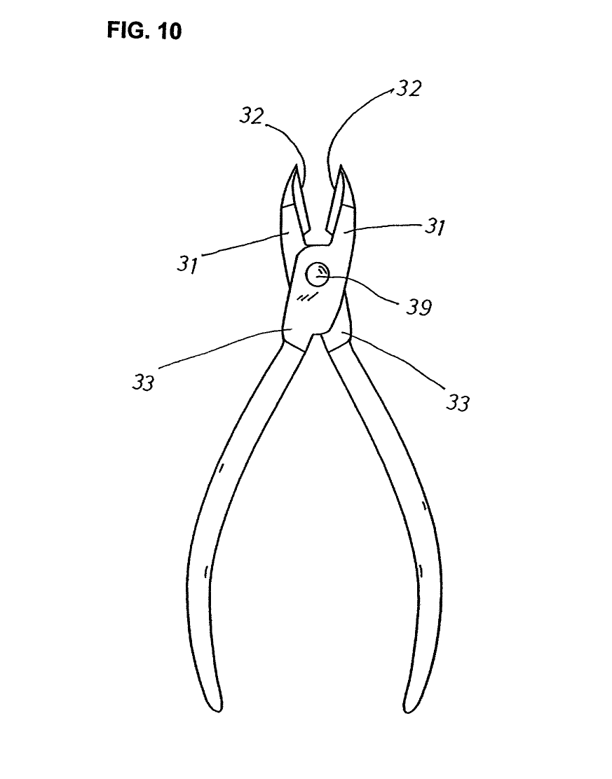

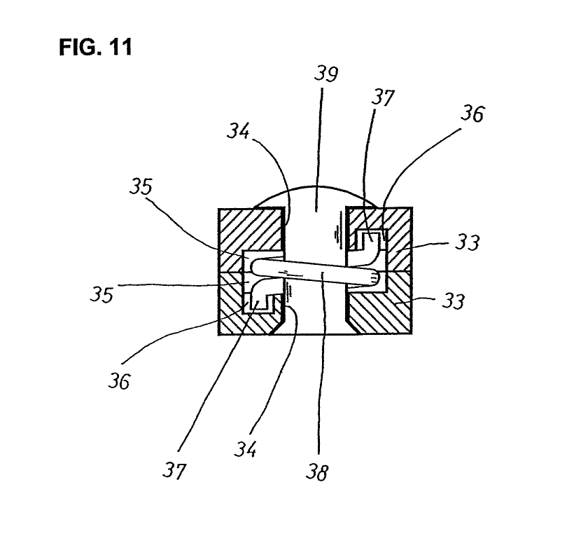

FIGS. 10 and 11 show a further embodiment of the present invention that is applied to a nipper-type cuticle cutter.

A nipper-type cuticle cutter does not cut by causing the blade portions to cross each other as in the case of scissors. Instead, as seen from FIG. 10, the cutting edges 32 of a pair of blade portions 31 face each other along the entire length of the blade portions 31, and cutting is accomplished by closing the blade portions 31 so that the cutting edges are pressed together with an object in between.

The present invention is applicable to such a cuticle cutter in the same manner as in the haircutting scissors described above. More specifically, as seen from FIG. 11, circular recessed portions 35 are formed in the inside surfaces of a pair of main cutting bodies 33 so as to be around the shaft holes 34, and anchoring holes 36 are formed in the bottoms of the recessed portions 35. A coil spring 38 (same type as that shown in FIG. 9) is mounted over the rivet-form pivot shaft 39 that is passed through the shaft holes 34, and anchoring projections 37 of the coil spring 38 are inserted in the anchoring holes 36 formed in the recessed portions 35. Both ends of the pivot shaft 39 are pressed so as to act as a pivot center.

As seen from the above, the present invention is applicable to a nail clipper that is of the above-described nipper-type.

1. A cutting tool in which a pair of main cutting bodies each comprising a blade portion and a handle section are connected by a pivot shaft so as to pivot relative to each other about said pivot shaft provided between said blade portion and said handle section, and said blade portions are driven in an opening direction by a spring, wherein
each one of said main cutting bodies is formed with a recessed portion in inside surface thereof so as to surround a shaft hole opened in each one of said main cutting bodies;
a spring is installed in a space that is formed by said recessed portions that are disposed to face each other;
said spring has two operating ends for applying a driving force that urges said blade portions in said opening direction, and
one of said two operating ends of said spring acts on a point in said recessed portion of one of said main cutting bodies and another one of said two operating ends of said spring acts on a point in said recessed portion of another one of said main cutting bodies.

2. The cutting tool according to claim 1, wherein said point in said recessed portion of each one of said main cutting bodies is located further toward said handle section with respect to an imaginary line that passes through a center of said shaft hole and is perpendicular to a direction of length of said blade portion.

3. The cutting tool according to claim 1 or 2, wherein said spring is a coil spring, said pivot shaft is passed through an interior of a cylindrical coil section of said spring, both end portions of a spring wire that forms said cylindrical coil section are bent substantially in opposite directions from each other so as to form said operating ends, and one of said operating ends is engaged with an anchoring hole formed in a bottom of said recessed portion of one of said main cutting bodies and another one of said operating ends is engaged with an anchoring hole formed in a bottom of said recessed portion of another one of said main cutting bodies.

4. The cutting tool according to claim 1 or 2, wherein said spring is a coil spring, said pivot shaft is passed through an interior of a cylindrical coil section of said spring, two arm portions protrude in a fan shape from said cylindrical coil section of said spring so that each end of said arm portions are bent substantially in opposite directions from each other so as to form said operating ends, and one of said operating ends is engaged with an anchoring hole formed in a bottom of said recessed portion of one of said main cutting bodies and another one of said operating ends is engaged with an anchoring hole formed in a bottom of said recessed portion of another one of said main cutting bodies.

5. The cutting tool according to claim 1 or 2, wherein said spring is a coil spring, said pivot shaft is passed through an interior of a cylindrical coil section of said spring, two arm portions protrude in a fan shape from said cylindrical coil section of said spring, and one of said two arms is engaged with an inner surface of said recessed portion of one of said main cutting bodies and another one of said operating ends is engaged with an inner surface of said recessed portion of another one of said main cutting bodies.

6. The cutting tool according to claim 1 or 2, wherein said cutting tool is of a type that cuts an object by causing said blade portions of said main cutting bodies to cross.

7. The cutting tool according to claim 1 or 2, wherein said cutting tool is of a type that cuts an object by causing said blade portions of said main cutting bodies to cross.

8. The cutting tool according to claim 3, wherein said cutting tool is of a type that cuts an object by causing said blade portions of said main cutting bodies to cross.

9. The cutting tool according to claim 4, wherein said cutting tool is of a type that cuts an object by causing said blade portions of said main cutting bodies to cross.

10. The cutting tool according to claim 5, wherein said cutting tool is of a type that cuts an object by causing said blade portions of said main cutting bodies to cross.

11. The cutting tool according to claim 3, wherein said cutting tool is of a type that cuts an object by causing said blade portions of said main cutting bodies to cross.

12. The cutting tool according to claim 4, wherein said cutting tool is of a type that cuts an object by causing said blade portions of said main cutting bodies to cross.

13. The cutting tool according to claim 5, wherein said cutting tool is of a type that cuts an object by causing said blade portions of said main cutting bodies to cross.
